(19) United States
(12) Patent Application Publication
(10) Pub. No.: US 2022/0142186 A1
(43) Pub. Date: May 12, 2022

(54) CUTTING TOOL

(71) Applicant: Merctech Pty Ltd, Holden Hill (AU)

(72) Inventor: Ennio MERCURI, Holden Hill (AU)

(73) Assignee: Merctech Pty Ltd, Holden Hill (AU)

(21) Appl. No.: 17/440,333

(22) PCT Filed: Mar. 18, 2020
(86) PCT No.: PCT/AU2020/000020

§ 371 Date: Sep. 17, 2021

(30) Foreign Application Priority Data
Mar. 18, 2019 (AU) 2019900890

(51) Int. Cl. A22C 13/02; B26B 29/06; B26D 7/06; B26D 7/10; B26F 3/08; A22C 17/00

(52) U.S. Cl. CPC A22C 13/02; B26B 29/06; B26D 7/06; A22C 2013/0056; B26F 3/08; A22C 17/0093; B26D 7/10

(57) ABSTRACT

A cutting tool for cutting netting used for encasing meat products comprises a blade and a guard. A control circuit is electrically connected to the blade, and configured to maintain the temperature of the blade at a cutting temperature in the range of 300° C. to 500° C. The guard defines an interior cavity surrounding the blade and further comprises a slot exposing a portion of the blade. The guarding is further shaped to define a funnel at a distal end of the cutting tool leading to the slot such that in use the funnel guides a netting to be cut towards the blade. The cutting tool may be provided as a hand tool or in a bench mounted form.

### PRIORITY DOCUMENTS

The present application claims priority from Australian Provisional Patent Application No. 2019900890 titled “CUTTING TOOL” and filed on 18 Mar. 2019, the content of which is hereby incorporated by reference in its entirety.

### TECHNICAL FIELD

The present disclosure relates to netted meat products. In a particular form the present disclosure relates to a cutting tool for cutting elastic netting on meat products.

### BACKGROUND

Referring now to FIG. 1, there is shown a meat netting system 1 comprising a tube 2 covered in an elastic netting 10. The elastic netting may be formed from a combination of inelastic and elastic yarn, such as rubber filaments wrapped with polyester threads. Meat products 4 are pushed through the tube 2 (arrow 6) towards distal end 8. After the meat exits the distal end of the tube 8 the meat is covered by the elastic netting 10. Before the next piece of meat exist the tube, the netting must be cut by an operator at a point 12 between the covered meat product 14 and the distal end of the tube 8. After cutting the netting the elasticity of the netting causes the end portion to constrict 16 around the end of the meat product 14.

Typically the netting is cut by an operator who catches the meat product, spins the meat product to cause a narrow constriction 12 of the netting, and then uses a pair of scissors to cut the narrow constricted netting 12. However a long standing problem with the use of scissors is that scissors do not cut the netting cleanly and release small fragments of netting, yarn and covered rubber which can drop onto the meat, or on the table surface where they can then stick to meat products thus contaminating the meat. This has led to customer complaints due to contamination of the meat as well as liability claims which in the past have exceeded 250,000.

Various approaches have made to try and prevent this contamination, such as cutting over a water bath or a sheet to try and catch falling fragments. However these approaches do not stop fragments falling on the meat, and restrict movement or working space of workers which can affect productivity, and such measures have generally failed to prevent ongoing contamination. There is thus a need to provide an improved cutting tool or system, or at least provide a useful alternative to existing tools and systems.

### SUMMARY

According to a first aspect, there is provided a cutting tool comprising:

a blade;

a guard defining an interior cavity surrounding the blade and further comprising a slot exposing a portion of the blade, wherein the guarding is shaped to define a funnel at a distal end of the cutting tool leading to the slot such that in use the funnel guides a netting to be cut towards the blade;

a control circuit electrically connected to the blade, and configured to maintain the temperature of the blade at a cutting temperature in the range of 300° C. to 500° C.

In one form, the funnel may comprise a first distal end and a second distal end which define a triangular funnel with a 90° opening angle located at the distal end of the cutting tool and the slot is an extended slot formed in the apex of the funnel leading to the blade. In a further form, the slot is between 6 mm and 8 mm wide, and has a length of at least 20 mm between the apex and the blade.

In one form, the guarding may be formed of a heat resistant material and comprises a plurality of ventilation holes each extending through the guarding from the interior cavity to an exterior surface. In a further form the guarding comprises two side surfaces, a top surface and a bottom surface wherein the top surface ends at the first distal end, and the bottom surface ends at the second distal end, and the plurality of ventilation holes are located on the side surfaces and top surfaces, but not the bottom surface.

In one form, the blade has a V shaped profile.

In one form the cutting temperature is between 350° C. and 450° C., and in a further form the cutting temperature is between 380° C. and 420° C.

In one form the cutting tool may further comprise a handle and a trigger, and wherein the control circuit is further configured to maintain the temperature of the blade at a first holding temperature below 240° C., and in response to actuation of the trigger, raises the temperature of the blade to the cutting temperature. In a further form, the first holding temperature may be between 200° C. and 240° C.

In another form, the guard is mounted to a support cabinet housing the control circuit, further comprising a bench mount for mounting the cabinet on a fixed surface.

In a further form, the cabinet may comprise a base, cover and four sides, and further comprising two identical mounting arrangements configured to mount the cabinet to a support, each located on two adjacent sides of the cabinet, and the guard and blade are mounted on another side of the cabinet to allow mounting of the guard and blade in two orthogonal orientation relative to the support. In a further form the support may comprise a vertical tubular post with a constant (fixed/regular) cross sectional profile mounted to a base, and wherein each mounting arrangement comprises at least one guide with an interior profile matching the cross sectional profile of the vertical tubular post, and at least one fastener configured to fasten the at least one guides to the post. In a further form, the at least one guide may comprise a pair of spaced apart guides, and a hand adjustable fastener associated with each guide comprising a screw threaded shaft that passes through the guide.

In a further form, the cutting tool may further comprise a vacuum extraction system comprising a capture hood, duct and vacuum extraction cabinet wherein the capture hood is mounted over the cutting blade. In one form the cabinet may be is mounted to the support using the first mounting arrangement and the capture hood is mounted over the cutting blade using the second mounting arrangement.

### BRIEF DESCRIPTION OF DRAWINGS

Embodiments of the present disclosure will be discussed with reference to the accompanying drawings wherein:

FIG. 1 is a schematic diagram of a meat netting system;

FIG. 2A is a side view of a cutting tool according to an embodiment;

FIG. 2B is a front view of the cutting of FIG. 2A;

FIG. 2C is a first perspective view of the cutting of FIG. 2A;

FIG. 2D is a second perspective view of the cutting of FIG. 2A;

FIG. 3A is an interior side view of a first side guard of a cutting tool according to an embodiment;

FIG. 3B is a top view of the first side guard of FIG. 3A;

FIG. 3C is an exterior side view of the first side guard of FIG. 3A;

FIG. 3D is a perspective view of the first side guard of FIG. 3A;

FIG. 4A is an interior side view of a second side guard of a cutting tool according to an embodiment;

FIG. 4B is a top view of the second side guard of FIG. 4A;

FIG. 4C is an exterior side view of the second side guard of FIG. 4A;

FIG. 4D is a perspective view of the second side guard of FIG. 4A;

FIG. 5 is a circuit diagram of a control circuit for the cutting tool according to an embodiment;

FIG. 6A illustrates a first embodiments of a cutting blade;

FIG. 6B illustrates a second embodiments of a cutting blade;

FIG. 6C illustrates a third embodiments of a cutting blade;

FIG. 7 shows a close up of netting received in the cutting blade shown in FIG. 6A; and

FIG. 8A is representation of the netting prior to cutting according to an embodiment;

FIG. 8B is representation of the netting during cutting according to an embodiment;

FIG. 8C is representation of the cut netting according to an embodiment;

FIG. 9A is a close up perspective view of a bench mounted cutting tool according to an embodiment;

FIG. 9B is a perspective view of a bench mounted cutting tool according to an embodiment;

FIG. 9C is a side view of a bench mounted cutting tool according to an embodiment;

FIG. 9D is a side view of a bench mounted cutting tool with the cover removed and with hidden edges shown as dashed lines according to an embodiment;

FIG. 9E is a top view of a bench mounted cutting tool with hidden edges shown as dashed lines according to an embodiment; and

FIG. 9F is a side view of a bench mounted cutting tool and a vacuum extraction system according to an embodiment.

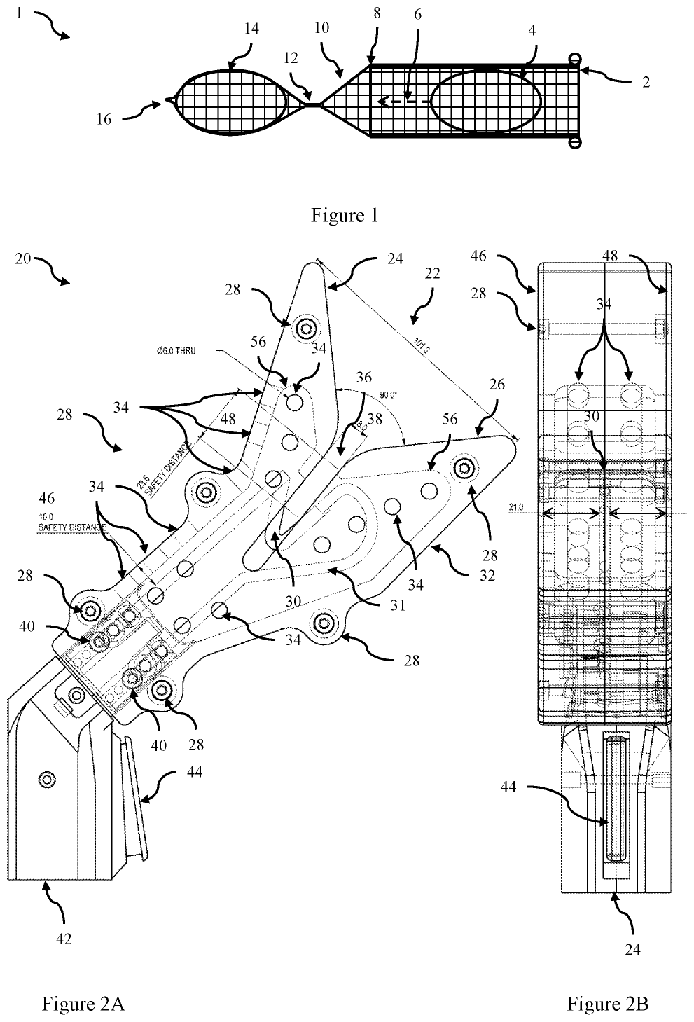

In the following description, like reference characters designate like or corresponding parts throughout the figures.

### DESCRIPTION OF EMBODIMENTS

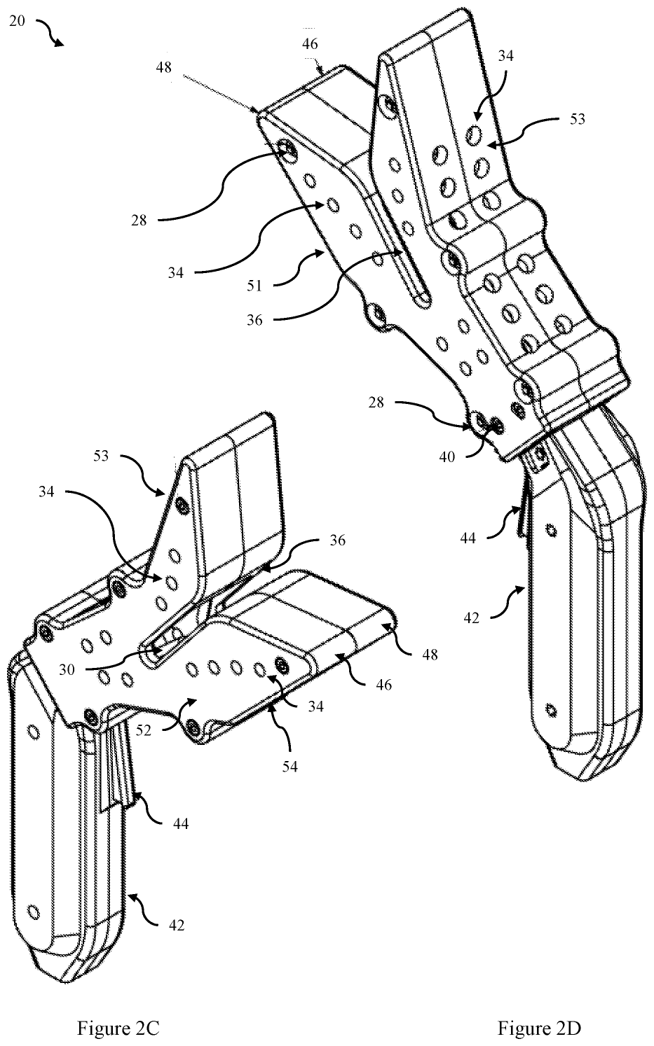

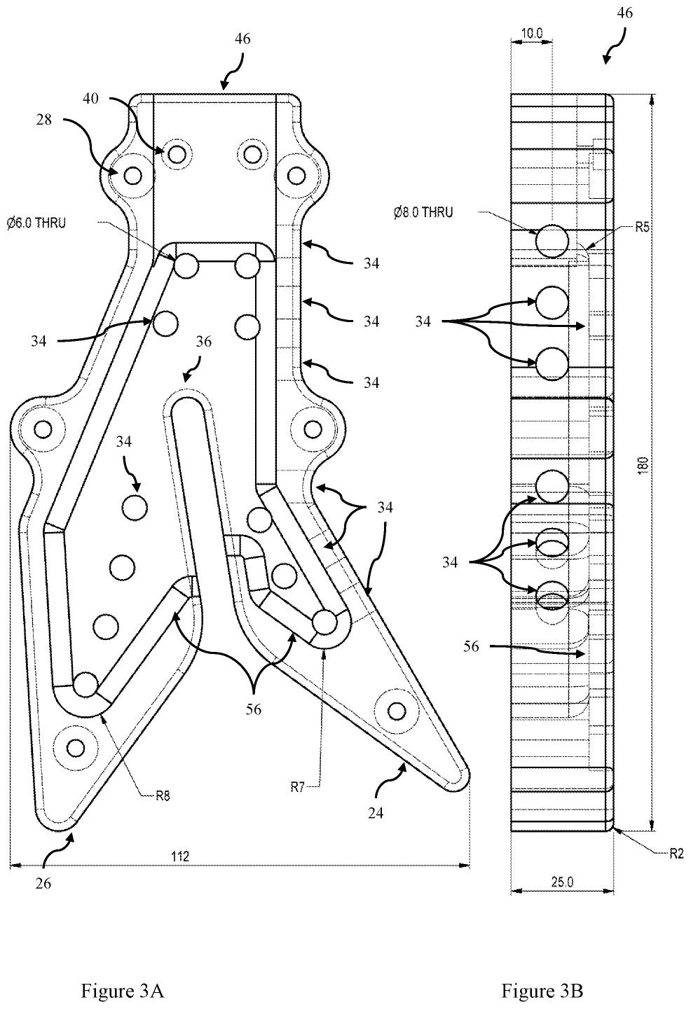

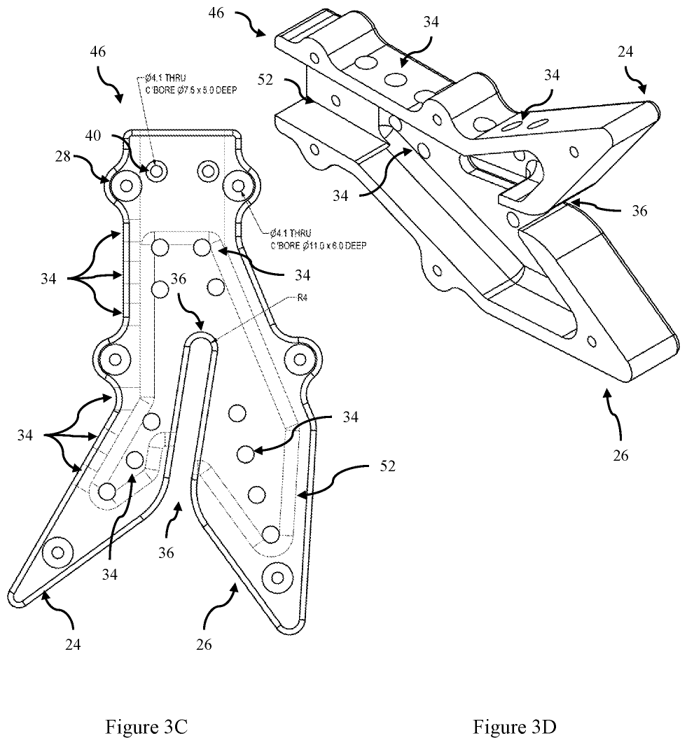

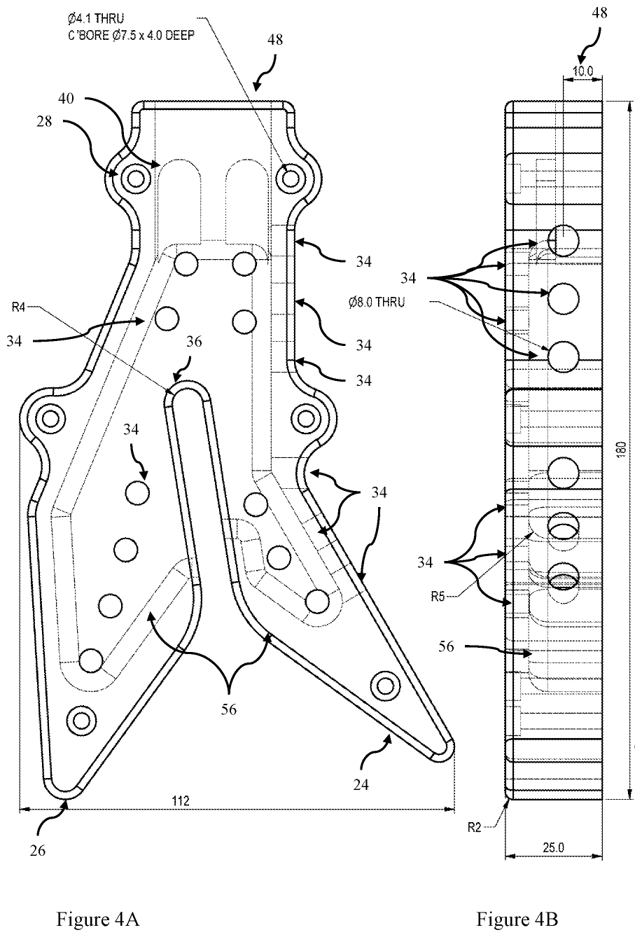

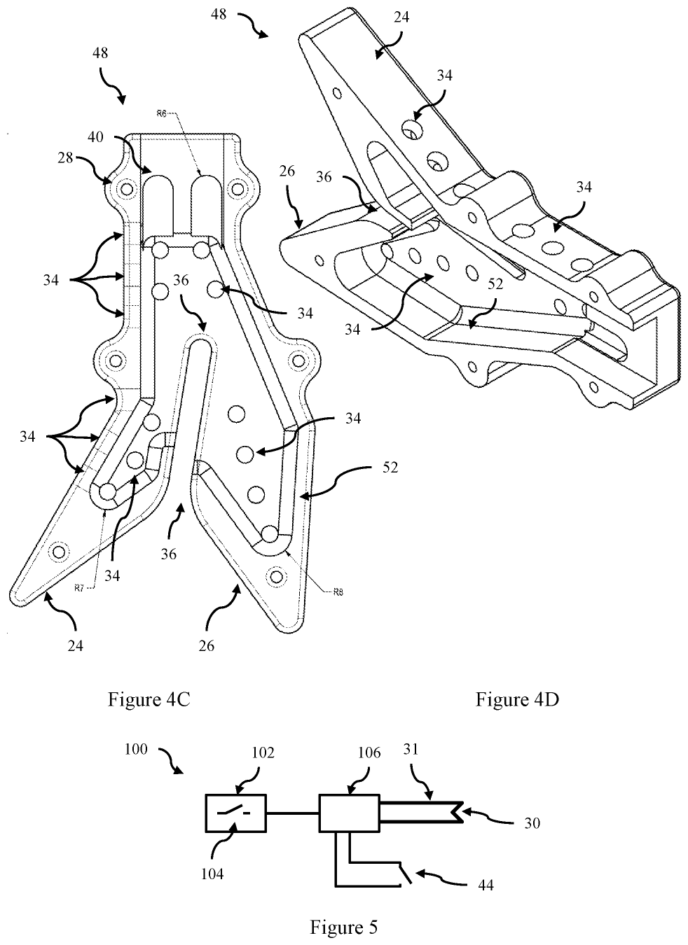

FIGS. 2A through 2D show side, front and two perspective views, respectively of a cutting tool 20 comprising a hot blade cutting element 30 according to an embodiment. The apparatus comprises a handle 42 which supports a curved cutting blade 30 that is electrically heated by a control circuit 100. The blade 30 is protected by guarding 32 formed from a left (or first side) guarding 46 and right (or second side) guarding 48 which are secured together using fasteners 28, such as six M4 bolts, and mounted to the handle using fasteners such as mounting bolts 40. FIG. 3A shows an interior side view of a first side guard 46 according to an embodiment. FIGS. 3B, 3C, and 3D show top, exterior side and a perspective view of the first side guard. Similarly FIG. 4A shows an interior side view of a second side guard 48 according to an embodiment. FIGS. 4B, 4C, and 4D show top, exterior side and a perspective view of the second side guard.

An embodiment of the control circuit 100 used to control the temperature of the cutting blade 30 is illustrated in FIG. 5. A power supply 102 provides power to the controller 106, which provides a heating current to the wires 31 connected to blade 30. The controller supplies a first current to maintain the blade 30 at first holding temperature whilst the trigger switch 44 is open (ie not depressed). Once the trigger switch 44 is actuated (ie closed, depressed or squeezed by the operator), the controller 106 increases the current to the blade 30 to rapidly raise the temperature of the blade to a cutting (or operating) temperature. The cutting temperature is selected to be a temperature sufficient to rapidly melt and cut through elastic and polyester netting. In some embodiments the power supply 104 may comprises a master on/off power switch 104 to locally control the power state of the cutting tool 20 (ie to completely switch off power supply to the cutting blade). The controller 106 may be a circuit comprising discrete analog or digital components, or a digital circuit including a microcontroller or microprocessor.

In one embodiment the holding temperature of the cutting blade is around 200° C. and the cutting temperature is at least 300° C. In one embodiment the holding temperature is between 220° C. and 240° C., and the cutting temperature is between 300° C. and 500° C. A cutting temperature of around 400° C. is suitable for efficiently cutting most materials. However high temperatures may be used such as a cutting temperature in the range of 450° C. to 500° C. A cutting temperature in this high range will very quickly melt and cut through netting (including polyester and rubber based netting) with minimal resistance. Preferably the controller provides sufficient current to the cutting blade to raise the temperature from the holding temperature to the cutting temperature within 5 seconds, and more preferably within 2 seconds. In some embodiments the controller is a simple open loop circuit arrangement that is configured to supply additional current to the blade whilst the switch 44 is depressed. In this embodiment the control circuit does not monitor the current, and essentially has two operating modes, namely a low current mode that supplies sufficient current to the blade to maintain the blade at the holding temperature and a high current mode, that supplies extra current to the blade to raise the temperature of the blade.

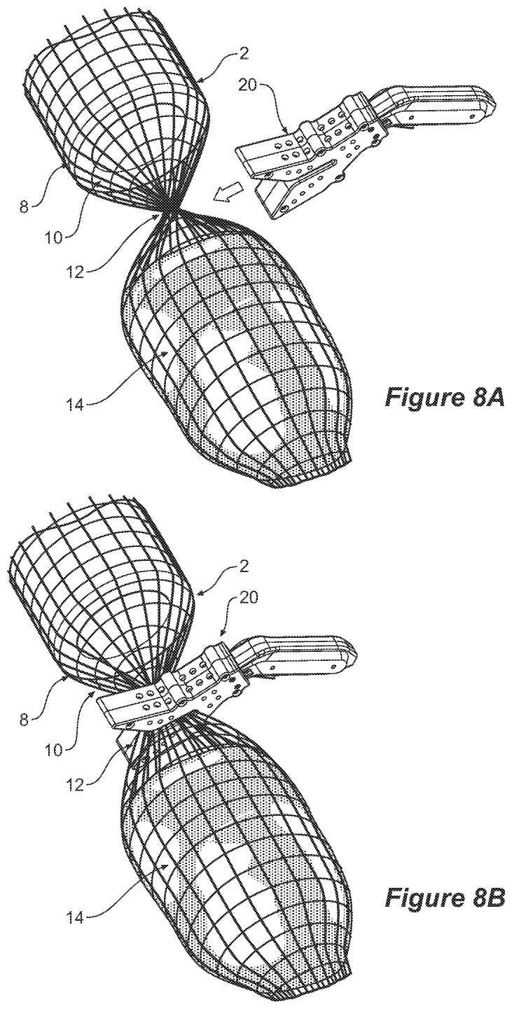

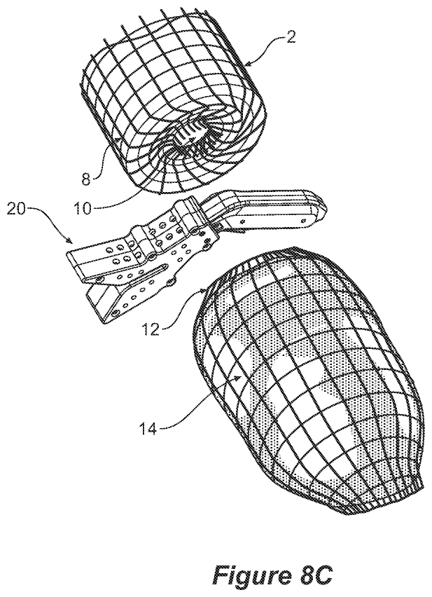

In other embodiments, the controller comprises a timer circuit (or timer logic), such that on depressing the trigger switch 44, the current is increased to raise the blade 30 to a cutting temperature for a predefined time-out period, after which the current is reduced to the maintenance current (or temperature). This time out period is set to a value which provides sufficient time to perform the cutting operation such as 2 to 5 seconds. Longer time periods such as 10, 15, 20, or 30 seconds may be used. This provides sufficient time for the blade to heat up to the operating temperature, and for the operator to grasp the meat and cut the netting, and for the blade to cool down (or begin to cool down) before the next cutting operation begins. FIGS. 8A to 8C shows representation of the cutting operation. In FIG. 8A an operator grasps and spins the meat to form a constriction point 12 and presses the trigger 44 to begin heating of the blade. Then in the operator moves the cutting tool 20 towards the netting and the guarding guides the constricted netting 12 towards the blade 30 which cuts the netting. In FIG. 8C the operator has moved the cutting tool 20 past the netting, and the blade has cleanly cut the netting, with one end of the netting springing back towards to tube 2, and the other end springing backing towards the portion 14, with both free ends returning to an unexpanded state. The entire cutting stroke (from FIG. 8A to 8C) takes less than 1 second.

In some embodiments the predefined time out period is a longer period such as 2, 5, or 10 minutes to ensure the blade is not accidentally left at a high temperature for an extended period of time. This avoids excessive power use and assists in extending the working life of the blade, as excessive time at high temperature can lead to premature blade failure (although this depends to some extent on the choice of the blade material).

In some embodiments the controller 106 monitors the temperature in the blade, and controls the current to the blade 30 to hold the blade at a desired temperature, or within a desired temperature range (ie a closed loop control circuit). In some embodiments the controller 106 monitors the temperature in the blade, and shuts down heating of the blade if the temperature meets or exceeds an upper limit. In some embodiments the controller provides a continuous current to the blade. In some embodiments the controller uses pulse width modulation to pulse current into the blade. In some embodiments a small fan may be included to assist in fume extraction and/or cooling of the blade. The control circuit 100 may comprise discrete circuit elements (resistors, capacitors, IC chips) mounted on a PCB. In some embodiments the control circuit may additionally comprise a microcontroller or microprocessor.

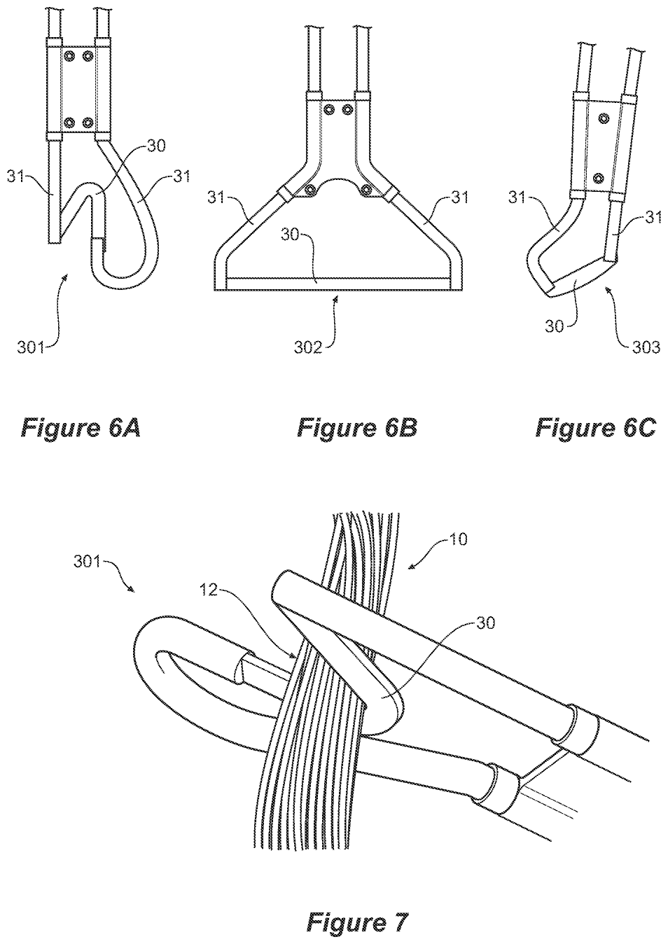

In one embodiment the blade 30 is formed from a metal alloy, and in particular a Nichrome metal alloy or other resistance wire materials that undergo efficient resistive (or Joule) heating. The blade 30 is mounted to and supported by thick wires 31 made of a less resistant metal alloy. FIGS. 6A to 6C illustrate three embodiments of the blade. FIG. 6A shows a first embodiment 301 in which the blade has a V shaped (or concave) profile, FIG. 6B shows a second embodiment 302 with a long straight blade, and FIG. 6C shows a third embodiment with a short slightly convex blade 303. A series of trials were performed comparing the three embodiments. Typically the netting bundle 12 is between 8-12 mm in diameter, and thus in these trials the first blade 301 had a 12 mm wide opening and 18 mm deep V section, the second blade 302 was 85 mm long, and the third blade 303 was 25 mm long. Each of the blades were formed from a Nichrome alloy.

The first blade 301 was found to require the least amount of energy to heat up with the second blade 302 requiring the most energy. This means that for a given input current, the first blade 301 will have a faster warm up time compared to second and third blades 302 and 303. It was additionally noted that the temperature varied across the length of the blade, with the temperature maximising in the centre.

The three blades were tested on cutting a netting bundle 12. FIG. 7 shows a close up view of the first blade 301 receiving the netting bundle 12 for cutting. The first blade 301 with the V shaped profile worked the best, as the V shape profile guided the netting into the hottest part of the blade. The third blade 303 also performed adequately, but the convex shape was found to spread the netting rather than cut it with the central hottest part of the blade. The second blade 302, exhibited a pronounced temperate gradient across the blade, and as noted above the central region was the hottest part of the blade. Thus most effective cutting was achieved when the netting was in the central portion, thus requiring guiding of the netting to the central portion, or use of higher currents to ensure that all portions of the blade were at a sufficiently high temperature to ensure rapid and easy cutting.

As the cutting tool is required to raise the temperature to a cutting temperature of 300° C. or more, a guard 32 is mounted to the handle 42 to protect the operator. FIGS. 2A through 4D shows various views of the tool and guarding according to an embodiment.

The guarding 32 is formed of a heat resistant plastic, or similar heat resistant material, with cutout portions 56 to define an internal cavity around the cutting blade 30 to allow heat and fumes to dissipate from the blade. The guarding comprises a plurality of ventilation holes 34 each extending through the guarding wall to allow heat generated by the heated blade 30 to escape, as well as any fumes. In this embodiment, and as shown in FIGS. 2C and 2D, the ventilation holes 34 are located on both side surfaces 51, 52 and the top surface 53, but not the bottom surface 54. This further assists capturing any melted polyester fragments and prevents such fragments from dropping out of the cutting tool. In this embodiment the holds are between 6 and 8 mm in diameter.

In this embodiment the guarding is formed as funnel guide 22 defined by first end 24 and second end 26 which define a triangular funnel with a 90° opening angle located at the distal end of the cutting tool. An extended slot 36 is formed in the apex (or neck) of the funnel 22 leading to the blade. In this embodiment the slot is between 6 mm and 8 mm wide, and has a length of at least 20 mm (in this embodiment 23.5 mm) between the edge of the opening and the blade. Additionally the top 53 and bottom 54 walls of the guarding 32 at least 10 mm from the wires 31, and the side walls 51 and 52 are at least 20 mm (in this case 21 mm) from the edge of the blade 30. In this embodiment the funnel has an opening width of 101.3 mm and each of the left and right guarding have a width of 25 mm (total width 50 mm) and a length of 180 mm (extending from the handle 42).

In this embodiment the total weight of the guard is 600 g, the weight of the handle and blade is 500 g, and the weight of the cable is 500 g giving a total weight of approx. 1.6 kg. This is well under the suggested limit for a hand tool of 2.3 kg (51b). Further it is well balanced due to the weight of the cable balancing out with the weight of the guard further reducing operator fatigue.

In one embodiment the guarding is formed from Polytetrafluoroethylene (PTFE) or the interior is coated with PTDE, or a similar heat resistant non-stick compound. This ensures that if any molten material is released during cutting it falls into the bottom of the guarding and is unlikely to stick due to the very good non-adhesion characteristics of PTFE. Over time the blade may build up a residue of melted plastic/carbon which may reduce the cutting efficiency. If this occurs the blade may be cleaned or replaced by remove the 6×M4 guard bolts 28 to allow removal of the guarding, and then loosening the 4×M5 bolts 28 that hold the blade in place.

The V shaped funnel guarding assists in guiding the netting towards slot. This allows the operator to easily gather and concentrate the netting through a simply swinging or linear motion that drive the tool towards and past the netting the hot so that the funnel concentrates the netting and directs the netting to the blade which quickly and easily melts and cut through the captured netting bundle. This cutting operation is illustrated in FIGS. 8A to 8C and can be easily performed in under 1 second.

In other embodiments other guarding shapes could be used, as well as other guarding blade geometries. For example a range of convex blade geometries could be used which assist in concentrating the netting towards the hottest part of the blade. Other geometries such as those illustrated in FIGS. 6B and 6C could be used, including concave geometries where the slot geometry 36 acts to drive the netting 12 to the hottest part of the blade 30. Whilst a V shaped funnel has been used, other guarding geometries including those with U Shaped ends or rounded geometries may be used.

In another embodiment, the cutting tool may be bench mounted, allowing permanent (or static) use on a production line. In one embodiment the cutting tool is bench mounted distal of the tube 2. This embodiment frees up the user from having to hold the cutting tool, and so instead can catch the meat portion with both hands as it ejected from the netting tube 2, spin the meat portion to constrict the netting, and then guide the constricted netting through the funnel to cut the netting. They can then place the meat product onto a conveyor belt and repeat the process with another meat portion. This reduces fatigue on the operator as they do not have to hold scissors or the cutting tool, thus further increasing production line efficiency.

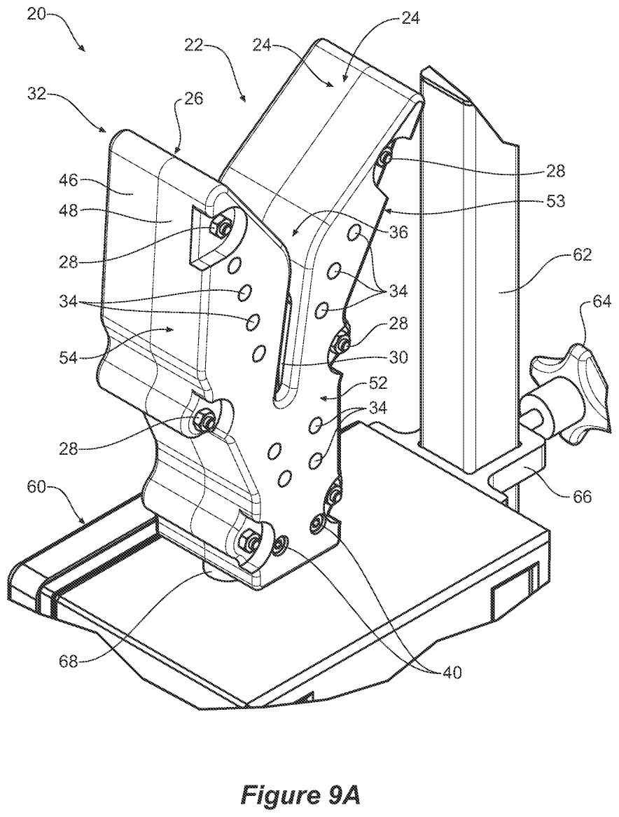

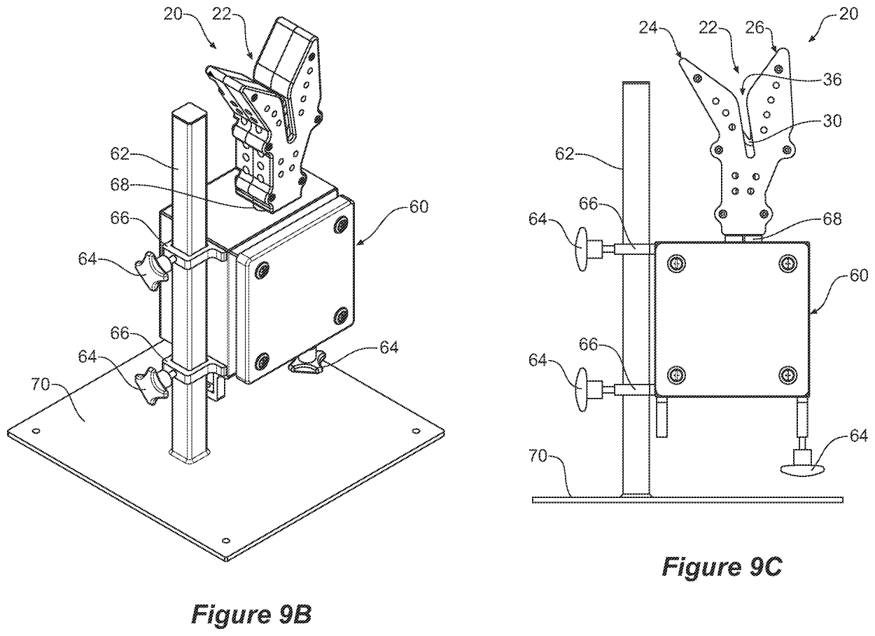

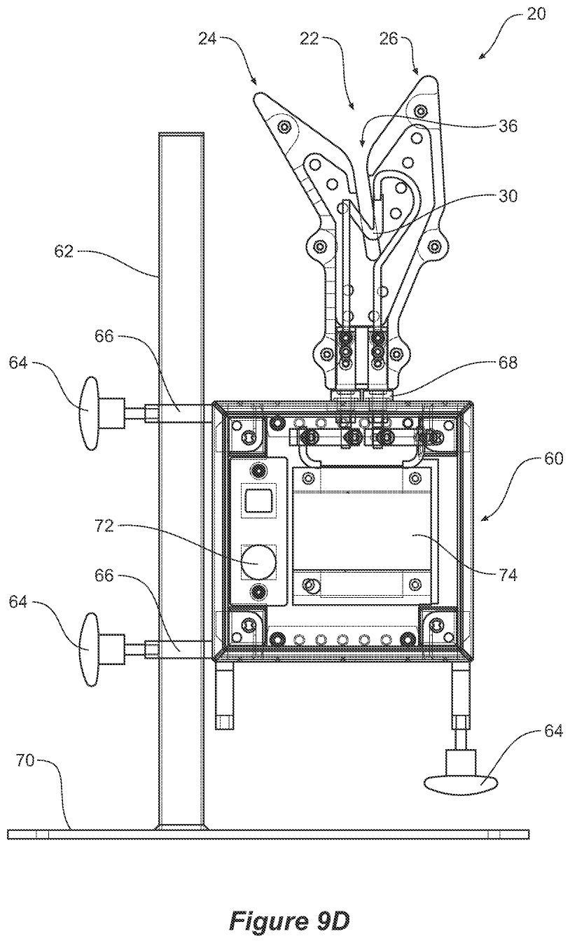

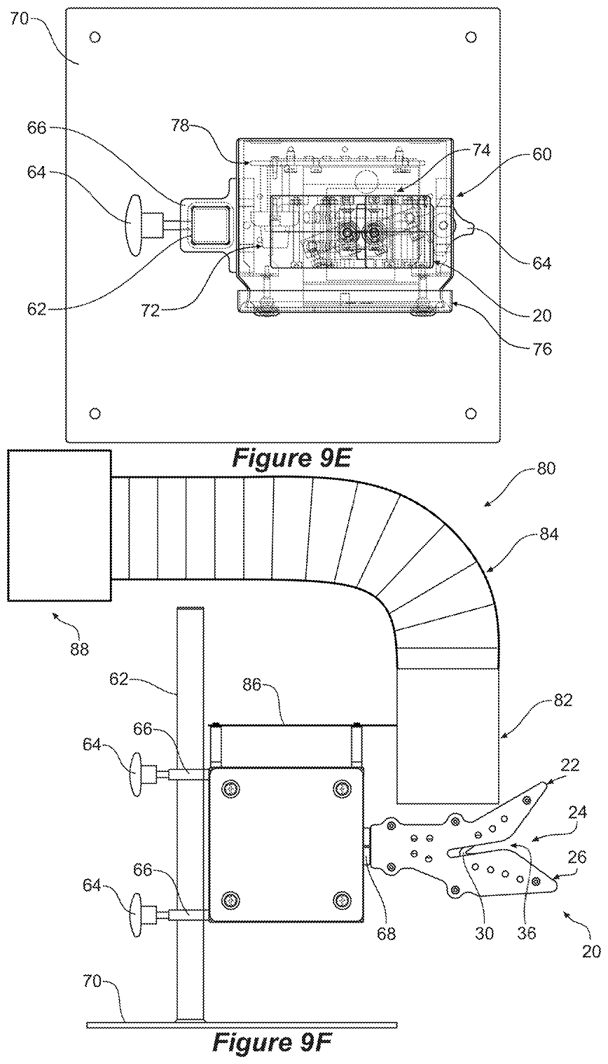

FIGS. 9B, 9C and 9C are perspective, side and top views of a bench mounted cutting tool 20 according to an embodiment. In this embodiment the cutting tool 20, including guard 46 and blade 30 but omitting the handle 42, are mounted via cabinet mount 68 to a cabinet 60 which is adapted to be mounted to a support post 62 extending from a base 70. The cabinet 60 comprises a box and a cover 76 secured to the base via fasteners such as 4 peripherally located screws. However other fastening arrangements such as bolts, clips, etc may be used, and the cover could be provided as a hinged cover with a single fastener such as lock. The box comprises a base opposite the cover, and 4 sides. On two adjacent sides are located identical mounting arrangements (ie two mounting arrangements), and the guard is mounted on a third side. Using two identical mounting arrangements on two adjacent sides allow the cabinet to be mounted to a post in two orthogonal orientations relative to a support surface (ie 90° rotated configurations/orientations). In a first configuration shown in FIGS. 9A to 9E, the guard 20 is vertically mounted, and in the second configuration shown in FIG. 9F, the guard 20 is horizontally mounted. In other embodiments the cabinet may be directly mounted on, or rests on a support surface (ie the post is omitted)

In this embodiment the base 70 comprises a vertically mounted post 62 with a constant rectangular profile. However in other embodiments the post may have a (fixed/regular) cross sectional profile such as circular, triangular, hexagonal, or octagonal profiles. The mounting arrangements each comprise a pair of spaced apart guides 66 with a matching rectangular interior profile (or dimensions) slightly larger than the rectangular profile (or dimensions) of the post 62 to allow the guides to be slid over the post. Each guide 66 has an associated fastener 64 which in this embodiment is a screw threaded shaft passing through a wall of the guide and a handle to allow the shaft to be driven against the post to fasten the cabinet in position. This arrangement allows the cabinet to be easily and quickly removed from the post when it is not required, or to allow quick rotation of the arrangement to suit the specific equipment or user preference. However in other embodiments a single guide and a single fastener may be used. This may be an elongated guide portion (eg elongated tube). In other embodiments three or more guides may be used. In some embodiments multiple guides may be used, with only a single fastener associated with one of the guides, or there may be more guides than fasteners.

The cabinet contains a chassis 78 which supports a power control circuit 100 and transformer 74 which powers the cutting blade 30 (via the cabinet mount). Power is supplied to the cabinet via a power cable (not shown) which in turn is connected to a power outlet. FIG. 9A is a close up perspective view of the guard mounted to the cabinet. FIG. 9D is another side view with the cover 76 removed and with hidden edges shown as dashed lines and FIG. 9E is a top view with hidden edges shown as dashed lines. These views show the interior arrangement of the cabinet 60 including the power control circuit 100, transformer 74 and chassis 78. The cutting tool 20 is mounted above the transformer 78 via mount 68. The wires 31 from the blade 30 pass through the mount and the ends are connected to the electrical mounts extending from the transformer which provides the power to heat the blade 30 (shown mostly clearly in FIG. 9D) under control of control circuit 100.

The bench mounted embodiments may be configured to operate at a fixed temperature, such as around 400° C. (eg ±5%), or the controller circuit may be configured to allow a variable temperature to be set to allow a user to set the appropriate temperature for the netting to be cut (eg between 300° C. to 500° C.). In embodiments with variable temperature control, a temperature selector 72 may be provided such as rotary dial, multi-position switch or push buttons. The temperature selector 72 may be an analog or digital component (for example a variable resistor or rotary encoder), and may allow continuous or discrete settings over a predefined range (eg every 25° C. or 50° C. over 300° C. to 500° C.). In the case of a digital component the control circuit may incorporate a microcontroller to interpret and apply input settings (eg map a button push to a selected power level/temperature setting). The temperature selector 72 may be internal to the cabinet (as is the case in the embodiment shown in FIGS. 9A to 9F), so that the temperature can only be set after removal of the cover 76 to prevent users from changing the temperature during normal use. Alternatively the temperature selector 72 may be an external component, for example located on the base, one of the side walls or the cover 76, and passing through the cabinet wall to send the signal designating the selected temperature to the internal control circuit 100 mounted on the chassis.

An on/off switch may also be incorporated. The on/off switch may be incorporated in the temperature selector (eg 0 setting or the end of an arc corresponds to an off state), or a separate on/off switch may be provided. Alternatively an on/off switch may be omitted and the device may always be on when connected to a power outlet (eg on/off control is via a switch on the power outlet). A visual power indicator such as LED may be located on the exterior of the cabinet to indicate power status. An emergency shut off button may also be located on the exterior of the cabinet to allow a user to shut off the apparatus in the case of an emergency.

The control circuit 100 is configured to control the power supplied to the cutting blade from the transformer based on the temperature selector. This may be an analog or digital circuit, and may include components to monitor the current or voltage levels, and include a safety circuit to shut down the system in the case that an error condition is detected (eg short circuit or overheating). The control circuit may be mounted as discrete components on the chassis 78 or on a PCB mounted to the chassis 78. Ventilation slots may be provided in the chassis to assist with heat dissipation from the transformer or control circuit 72.

In this embodiment where the cutting blade is mounted in a fixed position, the temperature may be set to a constant cutting temperature, as compared to the hand held embodiment which incorporated a trigger to raise the temperature from a holding temperature to a cutting temperature (that is there is no holding temperature and trigger). As previously the cutting temperature may be in the range of 300° C. to 500° C. The exact temperature selected will depend upon the material and thickness to be cut, with higher temperatures used for thicker or more heat resistant materials. In one embodiment a temperature of around 400° C. (measured at 391° C.) was found to be effective for repeatedly cutting most commonly used meat netting materials, with no loss of cutting efficiency or blade degradation over repeated trials. No overheating was observed with the guard allowing heat to safely dissipate away from the blade.

In another embodiment the bench mounted system may configured similar to the hand held cutting tool using a holding temperature and a cutting temperature via a foot trigger switch to allow the operator to control when the temperature is raised for cutting.

The netting may comprise various polyester (or PET) yarns as well as rubber or rubber coated threads. Cutting of these materials can release fumes or vapours which may potentially taint the meat product or irritate the operator. Thus in one embodiment a vacuum extraction system 80 is fitted over the cutting tool 20 to draw away any fumes. This prevents any contamination of the meat product from the cutting fumes, or exposure of the operator to the cutting fumes. FIG. 9F is a side view of a bench mounted cutting tool and a vacuum extraction system 80 according to an embodiment. In this embodiment the cutting tool 20 is mounted in the horizontal orientation to the support pole 62 via a first pair of guides 66 and fasteners 64. A capture hood (circular tube) 82 is located over the cutting blade 30 of the cutting tool by a flat plate 86 welded to the side of the capture hood and fastened (eg bolted or screwed) to each of the second pair of guides 66 on the cabinet side orthogonal to the post. A flexible duct 84 is connected to a vacuum extraction cabinet 88. This draws air past the cutting head into the capture hood and duct, and thus also drawing in any cutting fumes. The air may then be vented away from the user, or preferably passed through a series of filters. In one embodiment the capture hood 82 had a diameter of 100 mm and a 0.25 kW fan in the extraction cabinet 88 drew air in at a rate of 400 m³/h. This arrangement reduces fumes to safe limits such that the user does not need to wear any personal protective equipment, and prevents any contamination of the meat product.

Embodiments of the cutting tool described herein provide several advantages over prior systems and configured to enable long term and continuous use of the tool in an industrial setting. The cutting tool comprises hot blade and surrounding guard. The guard defines an interior cavity surrounding the a hot cutting blade and includes slot exposing a portion of the blade. A funnel is used to guide netting towards the slot and blade. The use of a hot blade allows the netting to be melted rather than cut, reducing the generation of fragments. Further if any molten fragments are generated they are contained within the guard. The cutting tool may be provided as a hand held tool incorporating a trigger and control circuit control to switch the temperature of the blade between a holding temperature (around 200° C. and 240° C.) and a cutting or operating temperature of at least 300° C., and preferably around 400° C. (±5%, ie between 380° C. and 420° C.). Alternatively the cutting tool may be bench mounted and held at a fixed temperature during use. In one embodiment the same guard and blade for the hand held unit is mounted onto a cabinet which may be mounted to a post. This allows the cutting blade to be mounted in multiple locations including horizontal and vertical orientations. In one embodiment a vacuum extraction system may be incorporated to prevent any fumes contaminating the meat product (potentially affecting the flavour) or creating a hazard for the user. Embodiments of the cutting tool both reduce the risk of contamination of the meat product with cut fragments, and further allow faster and easier cutting compared to manual methods such as scissors. The heat assisted cutting requires less force than scissors, and thus less fatigue on the user. The bench mounted embodiment also frees the user from holding a pair of scissors (in addition to the meat product), allowing them to concentrate on holding the meat and simply grasp the netting and passing through the static/fixed cutting blade. This saves time and reduces operator effort thus increasing production line efficiency whilst reducing risk to the manufacturer.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

It will be appreciated by those skilled in the art that the disclosure is not restricted in its use to the particular application or applications described. Neither is the present disclosure restricted in its preferred embodiment with regard to the particular elements and/or features described or depicted herein. It will be appreciated that the disclosure is not limited to the embodiment or embodiments disclosed, but is capable of numerous rearrangements, modifications and substitutions without departing from the scope as set forth and defined by the following claims.

1-16. (canceled)

17. A cutting tool comprising:
a blade;
a guard defining an interior cavity surrounding the blade and further comprising a slot exposing a portion of the blade, wherein the guarding is shaped to define a funnel at a distal end of the cutting tool leading to the slot such that in use the funnel guides a netting to be cut towards the blade;
a control circuit electrically connected to the blade, and configured to maintain the temperature of the blade at a cutting temperature in the range of 300° C. to 500° C.

18. The cutting tool as claimed in claim 17, wherein the funnel comprises a first distal end and a second distal end which define a triangular funnel with a 90° opening angle located at the distal end of the cutting tool and the slot is an extended slot formed in the apex of the funnel leading to the blade.

19. The cutting tool as claimed in claim 18 wherein the slot is between 6 mm and 8 mm wide, and has a length of at least 20 mm between the apex and the blade.

20. The cutting tool as claimed in claim 17, wherein the guarding is formed of a heat resistant material and comprises a plurality of ventilation holes each extending through the guarding from the interior cavity to an exterior surface.

21. The cutting tool as claimed in claim 20, wherein the guarding comprises two side surfaces, a top surface and a bottom surface wherein the top surface ends at the first distal end, and the bottom surface ends at the second distal end, and the plurality of ventilation holes are located on the side surfaces and top surfaces, but not the bottom surface.

22. The cutting tool as claimed in claim 17, wherein the blade has a V shaped profile.

23. The cutting tool as claimed in claim 17, wherein the cutting temperature is between 350° C. and 450° C.

24. The cutting tool as claimed in claim 23, wherein the cutting temperature is between 380° C. and 420° C.

25. The cutting tool as claimed in claim 17, further comprising a handle and a trigger, and wherein the control circuit is further configured to maintain the temperature of the blade at a first holding temperature below 240° C., and in response to actuation of the trigger, raises the temperature of the blade to the cutting temperature.

26. The cutting tool as claimed in claim 25, wherein the first holding temperature is between 200° C. and 240° C.

27. The cutting tool as claimed in claim 17, wherein the guard is mounted to a support cabinet housing the control circuit, further comprising a bench mount for mounting the cabinet on a fixed surface.

28. The cutting tool as claimed in claim 27, wherein the cabinet comprises a base, cover and four sides, and further comprising two identical mounting arrangements configured to mount the cabinet to a support, each located on two adjacent sides of the cabinet, and the guard and blade are mounted on another side of the cabinet to allow mounting of the guard and blade in two orthogonal orientation relative to the support.

29. The cutting tool as claimed in claim 28, wherein the support comprises a vertical tubular post with a constant (fixed/regular) cross sectional profile mounted to a base, and wherein each mounting arrangement comprises at least one guide with an interior profile matching the cross sectional profile of the vertical tubular post, and at least one fastener configured to fasten the at least one guides to the post.

30. The cutting tool as claimed in claim 29, wherein the at least one guide comprises a pair of spaced apart guides, and a hand adjustable fastener associated with each guide comprising a screw threaded shaft that passes through the guide.

31. The cutting tool as claimed in claim 27, further comprising a vacuum extraction system comprising a capture hood, duct and vacuum extraction cabinet wherein the capture hood is mounted over the cutting blade.

32. The cutting tool as claimed in claim 31, wherein the cabinet is mounted to the support using the first mounting arrangement and the capture hood is mounted over the cutting blade using the second mounting arrangement.
